(19) United States
(12) Patent Application Publication
(10) Pub. No.: US 2016/0113253 A1
(43) Pub. Date: Apr. 28, 2016

(54) AQUACULTURE NET WITH INNER FRAME

(71) Applicant: NV BEKAERT SA, Zwevegem (BE)

(72) Inventors: Gonzalo CEA, Talcahuano (CL); Alejandro SUAZO LUENGO, Talcahuano (CL); Hector PAREDES MONTECINOS, Talcahuano (CL)

(73) Assignee: NV BEKAERT SA, Zwevegem (BE)

(21) Appl. No.: 14/890,802

(22) PCT Filed: May 8, 2014
(86) PCT No.: PCT/EP2014/059438

§ 371 Date: Nov. 12, 2015

(30) Foreign Application Priority Data
May 15, 2013 (EP) 13167829.4

(51) Int. Cl. A01K 74/00; A01K 99/00

(52) U.S. Cl. CPC A01K 74/00; A01K 99/00

(57) ABSTRACT

An aquaculture net (1) comprises wires that form sidewalls (2) and a bottom (3) of the net (1). The sidewalls (2) form a perimeter for the aquaculture net (1). The aquaculture net (1) further comprises a frame (4) fitting inside the perimeter and leaving a gap between the frame (4) and the perimeter. The frame (4) has a removable auxiliary net (5) inside the frame. The frame (4) is movable up and down inside the perimeter. The frame (4) is provided with bristles or brushes (6) pointing outwards the frame and bridging the gap between the frame (4) and the perimeter.

### TECHNICAL FIELD

The invention relates to an aquaculture net with wires.

### BACKGROUND ART

Aquaculture nets or fish-farming nets are used to raise aquatic life such as fish. The aquaculture net keeps the aquatic life controlled and contained and protects the aquatic life inside the net against predators such as sharks.

The dimensions of such an aquaculture net are considerable. An example of a typical dimension is 30 m×30 m×15 m, the last dimension being the depth of the net inside the water and the first two dimensions being the width and length of the net at the water surface. A net made of galvanized steel wire and of the above-mentioned dimensions has a weight above 4 metric tonnes.

The aquaculture nets are usually of the chain-link fence type. This is a fence of steel wires woven into a diamond pattern. The meshes have a dimension that is smaller than the dimension of the fish. Each steel wire is preformed by bending so that it exhibits a wavy pattern with maxima and minima. The maxima of a steel wire interlock with the minima of a neighbouring wire to form the patterns of a series of diamonds.

Aquaculture nets of the chain-link fence type have proven to be successful to control the aquatic life and to protect against predators. Aquaculture nets with metal wires offer an acceptable resistance against bio-fouling, i.e. against fouling organisms such as barnacles, algae or molluscs, which may attach themselves to the wire material of the mesh structure and grow.

Following treatments regularly occur during the raising of aquatic life and during the lifetime of an aquaculture net.

A first treatment is the cleaning of the nets. Despite the good anti-fouling property of nets with metallic wires, the fouling mechanism is so persistent that entire openings in the meshes may be eventually filled blocking any introduction of fresh water or nutrition into the volume inside the mesh structure. Cleaning of the nets either in a mechanical way or by means of ultra violet radiation helps to increase the quality of the fish raising and to increase the lifetime of the aquaculture nets.

A second treatment is that the fish inside the aquaculture nets must be treated regularly against parasites. For this purpose, the fish need to be contained in a decreased net volume. This is also the case for fish sampling for determining growth rate, vaccination and other activities such as the harvesting itself, all activities which are proper to the fish farming industry. The fish need to be brought up closer to the surface of the net.

One way to solve this is by using a second soft (nylon) net inside the steel wire net. The soft net is applied inside the net so that it encloses the fish. By lifting the bottom of the soft net the fish are gathered in a smaller net volume, hereby increasing the fish content per volume. Once the bottom is lifted at suitable level, the surrounded and minimized volume is internally covered by sailcloth for keeping anti-parasite substance diluted inside the water in contact with the fish and avoiding that the anti-parasite substance dilutes into the rest of the water thus becoming too low concentrated and without any effect. However, this is a time consuming operation needing enough divers to help apply the net. Furthermore, some fish may escape from the soft net when applying it to enclose them.

A third treatment concerns the fish displacement back from an upper level to a lower level inside the aquaculture net, for avoiding fish contact with infectious water volume and/or parasites bloom. In the prior art this is done by moving the whole net to reach a suitable depth. Needless to mention that this is a complex operation that needs expensive material.

Moreover, metallic chain-link fence type nets cannot be lifted in this way, due to the stiffness and high weight of the net.

### DISCLOSURE OF INVENTION

It is an object of the invention to avoid the disadvantages of the prior art.

It is another object of the invention to clean nets in an efficient way.

It is also an object of the invention to provide an aquaculture net with means for gathering fish in a smaller volume near the surface of the net.

It is a further object of the invention to provide an aquaculture net with means for moving fish downwards in the net.

It is still another object of the present invention to provide an aquaculture net which is able to clean nets in an efficient way, to gather fish in a smaller volume near the surface of the net, and to move fish downwards in the net.

According to a first aspect of the present invention, there is provided an aquaculture net comprising wires that form sidewalls and a bottom of the net. The sidewalls form a perimeter for the aquaculture net. The aquaculture net further comprises a frame fitting inside the perimeter and leaving a gap between the frame and the perimeter. The frame is preferably a planar frame. The frame has a removable auxiliary net inside the frame. The frame is movable up and down inside the perimeter. The frame is provided with bristles or brushes pointing outwards the frame and bridging the gap between the frame and the perimeter.

The invention is applicable regardless of the exact geometry of the aquaculture net and applies to rectangular, square, circular, oval, hexagonal, octagonal . . . nets. In the case of circular nets, the term “walls” refer to the single cylindrical wall of the net made from various net parts which are assembled together e.g. by means of clips or by means of a helical wire or rope.

The movable character of the frame inside the net allows to direct and to move fish inside the aquaculture net upwards or downwards and to decrease the volume inside which the fish are able to move.

The bristles or brushes fixed to the frame have a double function.

First of all they avoid that fish can escape through the gap that is left between the frame and the perimeter.

The gap may have dimensions ranging from 0 cm to 10 cm, preferably from 0.1 cm to 10 cm, most preferably from 0.5 cm to 10 cm.

Secondly, during the movement of the frame, the bristles or brushes clean the nets from fouling organisms. This is the reason why the bristles or brushes have a length that is greater than the gap. This length preferably ranges from 10 cm to 25 cm.

Preferably the aquaculture net is made from metal wires, e.g. metal coated steel wires, such as stainless steel wires with a copper nickel coating or copper nickel tin coating on top of it. The diameter of the metal wires may range between 1.5 mm and 5.0 mm, e.g. between 2.0 mm and 4.0 mm. The tensile strength of the wires is preferably above 1200 MPa, e.g. above 1500 MPa.

The frame may be made of stainless steel, carbon, polymer, or polymer coated plain carbon steel. The polymer or polymer coating may be a high-density polyethylene (HDPE). Frames from stainless steel or coated plain carbon steels have the advantage of being stiff and of allowing only low degrees of deformation.

The terms plain carbon steel refer to carbon steels with only small amounts of alloying elements. Such a typical plain carbon steel composition has a minimum carbon content of 0.25%, a manganese content ranging from 0.20% to 0.80%, a silicon content ranging from 0.10% to 0.60%, a maximum sulfur content of 0.03%, a maximum phosphorus content of 0.30%, all percentages being percentages by weight. Other elements such as chromium, vanadium, nickel, boron, . . . are only present in amounts of maximum 0.4%, preferably of maximum 0.2%.

The bristles or brushes may be made of a polymer or a metal. The polymer may be a high-density polyethylene (HDPE). The metal may be steel and may be coated.

The removable auxiliary net may be made of a polymer such as nylon.

As mentioned, preferably the bristles or brushes not only bridge the gap between the frame and the perimeter but reach into the metal wires and the net to improve cleaning of the net.

According to a second aspect of the present invention, there is provided a method, in particular for transporting, relocating or lifting fish with following steps:

a) providing an aquaculture net according to the first aspect of the invention, wherein the frame is positioned at the bottom of the aquaculture net and where an auxiliary net is attached to the frame;

b) lifting the frame inside said perimeter up thereby simultaneously cleaning the walls and decreasing the volume where the fish are present.

Once the volume with the fish has been decreased to a proper extent, fish can be sampled for determining the growth rate or the general status of the fish, or the fish can be vaccinated or the fish can be harvested.

Following step may be added to the method:

c) attaching an impermeable cloth to the underside of the frame and auxiliary net.

This additional step allows treating the fish in the decreased volume against parasites. The impermeable cloth prevents the anti-parasite substance from diluting inside a bigger volume of water.

Still other steps may be added to the method:
removing the impermeable cloth (if any);
removing the auxiliary net from the frame in order to increase the volume where fish can freely move;
moving the frame to the top;
attaching the auxiliary net to the frame again.

The result of these additional steps is that the fish are all below the frame now.

If one further moves the frame downwards then two functions are performed simultaneously:
the wires of the walls of the aquaculture net are cleaned;
the fish are push downwards e.g. for avoiding that the fish come into contact with infectious water and/or with parasites bloom.

### BRIEF DESCRIPTION OF DRAWINGS

FIG. 1 is a perspective view of an aquaculture net according to the invention;

FIG. 2 is a top view of an aquaculture net according to the invention;

FIG. 3 shows a top view of part of a frame;

FIG. 4 shows a perspective view of part of a frame.

### DESCRIPTION OF PREFERRED EMBODIMENTS

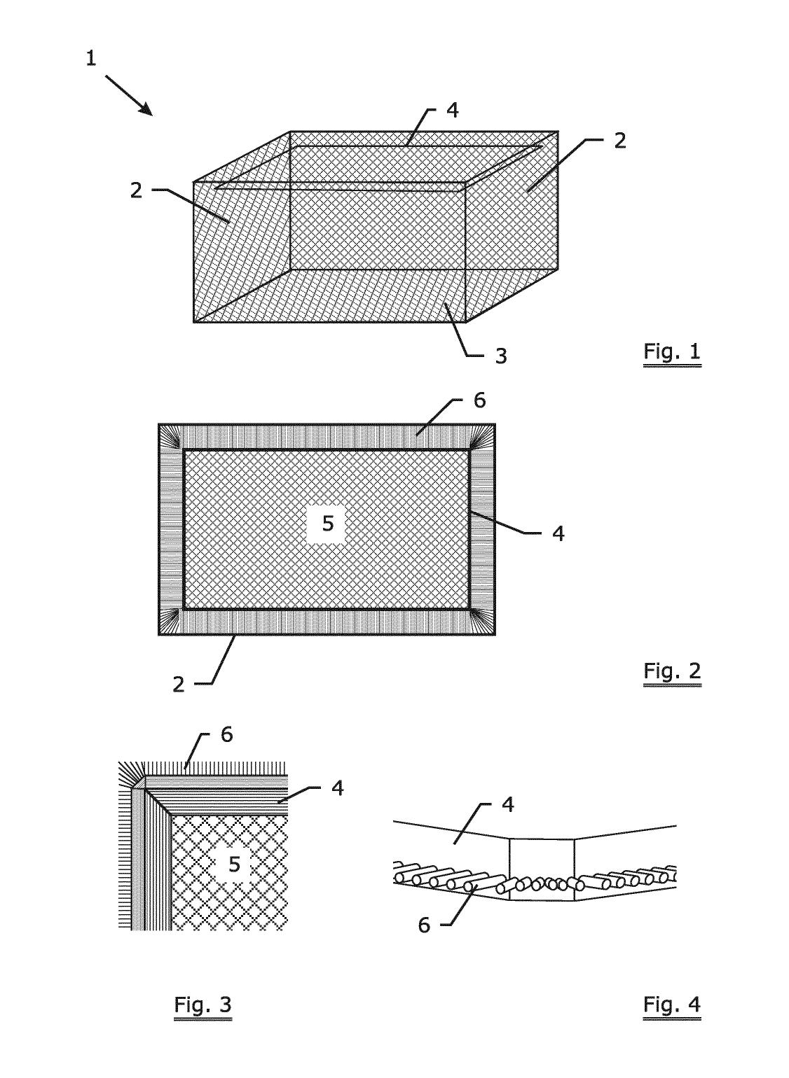

Referring to both FIGS. 1 and 2, a rectangular aquaculture net 1 has four side walls 2 which form the perimeter of the net 1. A bottom 3 closes the aquaculture net 1 at the under side. The side walls 2 are made from a chain-link fence from metal coated stainless steels.

A stainless steel frame 4 fits inside the perimeter of the net 1. In order to allow this fit and movement of the frame 4 inside the net 1, there is a small gap of a few centimetres between the frame 4 and the perimeter formed by the side walls 2. An auxiliary soft net 5, i.e. a light weight net made of nylon, is removably attached inside the frame 4.

The net 5 is preferably easily removable so that a rapid change can be accomplished from e.g. a fish handling operation to a fish displacement operation. Similarly the net 5 must be attachable to the frame 4 in a rapid way.

The frame from stainless steel has the advantage of being stiff enough and allowing only limited deformations. This is needed to ensure an easy movement for the device inside the net without getting trapped or entangled with the metallic fence of the side walls 2.

Referring now also to FIGS. 3 and 4, HDPE bristles or brushes 6 are attached to the frame and are directed outwards, thereby bridging the gap between the frame 4 and the side walls 2. These brushes 6 not only bridge the gap but penetrate inside the meshes of the side walls 2 in order to clean the side walls whenever the frame 4 is moving upward or downward. The brushes 6 are positioned close enough to each other in order to prevent fish from escaping. In that respect the density of the brushes 6 at the corners may be higher than the density of the brushes 6 along the side walls 2.

### LIST OF REFERENCE NUMBERS

1 net
2 side walls
3 bottom
4 frame
5 netting
6 brushes

1.-13. (canceled)

14. An aquaculture net comprising wires that form sidewalls and a bottom of the net,
said sidewalls forming a perimeter for said aquaculture net,
said aquaculture net further comprising a frame fitting inside said perimeter and leaving a gap between said frame and said perimeter, said frame having a removable auxiliary net inside said frame, said frame being movable up and down inside said perimeter, said frame being provided with bristles or brushes pointing outwards said frame and bridging the gap between said frame and said perimeter.

15. An aquaculture net according to claim 14,
where said aquaculture net is a net of metal wires.

16. An aquaculture net according to claim 14,
wherein said frame is made from stainless steel, carbon, polymer, or polymer coated plain carbon steel.

17. An aquaculture net according to claim 14,
wherein said bristles or brushes are made from metal, polymer or polymer coated metal.

18. An aquaculture net according to claim 14, wherein said gap has a dimension ranging from 0 cm to 10 cm.

19. An aquaculture net according to claim 15,
wherein said bristles or brushes reach into said metal wires to improve cleaning of said metal wires.

20. An aquaculture net according to claim 19, wherein said bristles or brushes have a length ranging from 10 cm to 25 cm.

21. An aquaculture net according to claim 14,
wherein said removable auxiliary net is made of a polymer material such as nylon.

22. A method for transporting fish, said method comprising the steps of:
a) providing an aquaculture net according to claim 14 wherein said frame is positioned at the bottom of said aquaculture net and an auxiliary net is attached to said frame;
b) lifting said frame inside said perimeter up thereby simultaneously cleaning said walls and decreasing the volume where the fish are present.

23. A method for transporting fish according to claim 22, wherein the following step is performed:
c) an impermeable cloth is attached to the underside of said frame and auxiliary net.

24. A method for transporting fish according to claim 23, wherein one or more of the following operations is or are performed:
d) sampling fish for determining growth rate or status; and/or
e) treating fish against parasites; and/or
f) applying a vaccination to the fish; and/or
g) harvesting the fish.

25. A method for transporting fish according to claim 24, wherein one or more of the following steps is or are performed:
h) removing said impermeable cloth;
i) removing said auxiliary net from said frame in order to increase the volume and to allow fishes to penetrate;
j) moving said frame to the top and attaching said auxiliary net to said frame.

26. A method for transporting fish according to claim 25, wherein the following step is performed:
k) said frame is moved downward thereby simultaneously cleaning said walls and pushing said fish downward.
